(19) United States
(12) Patent Application Publication
(10) Pub. No.: US 2018/0189898 A1
(43) Pub. Date: Jul. 5, 2018

(54) CLUSTER ANALYSIS BASED POWER TRANSMISSION LINE MOUNTAIN FIRE RISKY AREA DIVISION METHOD

(71) Applicants: STATE GRID CORPORATION OF CHINA, Beijing (CN); STATE GRID HUNAN ELECTRIC POWER COMPANY, Hunan (CN); STATE GRID HUNAN ELECTRIC COMPANY DISASTER PREVENTION AND REDUCTION CENTER, Hunan (CN)

(72) Inventors: Jiazheng Lu, Beijing (CN); Tejun Zhou, Beijing (CN); Hongxian Zhang, Beijing (CN); Zhen Fang, Beijing (CN); Bo Li, Beijing (CN); Chuanping Wu, Beijing (CN)

(21) Appl. No.: 15/524,624

(22) PCT Filed: Aug. 4, 2016
(86) PCT No.: PCT/CN2016/093181

§ 371 Date: May 5, 2017

(30) Foreign Application Priority Data
Aug. 24, 2015 (CN) 201510524110.2

(51) Int. Cl. G06Q 50/06; G08B 17/00; G06K 9/00; G06K 9/62

(52) U.S. Cl. CPC G06Q 50/06; G06K 9/6219; G06K 9/0063; G08B 17/005

(57) ABSTRACT

A cluster analysis based power transmission line mountain fire risky area division method, which falls within the technical field of power transmission and distribution. Based on satellite fire point monitoring data, according to a proposed cluster distance index, a sample sequence is moved to another cluster and a cluster result is obtained by calculating the cluster distance index many times and moving same, so as to obtain power transmission line mountain fire risky distribution area division of a research area, serving as a basis for a refined forecast of power transmission line mountain fires and prevention and control of the power transmission line mountain fires. The method can be used to guide the deployment of fire extinguishing teams and fire extinguishing materials in a power transmission line mountain fire high-prevalence area, thereby enhancing the power grid mountain fire extinguishing capability.

### TECHNICAL FIELD

The present invention belongs to the field of power transmission and distribution technology, and in particular relates to a method for dividing a wildfire risk area for power transmission lines based on clustering analysis.

### BACKGROUND

With the continual increase of national economy, massive construction of power transmission lines makes the tense situation of electric power corridors serious increasingly, many corridors of the power transmission lines are established inevitably in high-incidence areas of wildfires. In recent years, wildfires due to the power transmission lines occur frequently, and bring a serious threat to our country's power system. As shown from statistic data from the power grid company, the situation of tripping operation of power transmission lines caused by wildfires is more and more serious. However, our country covers a vast and complicated terrain, distribution of vegetation resources of various regions is different, and folk tradition of various regions is also different. Meanwhile, wildfire distribution is influenced by local economic level and population density, and these factors lead to a sufficient difference in distribution of wildfires in various regions. However, there are a grid partition method based on an electrical distance and a grid partition method based on community discovery at present. The grid partition method based on community discovery uses power flow and impedance parameters as varying weights to build a complex network model, so as to obtain the grid partition result. Patent publication CN104614783A discloses a method of determining meteorological risks of the environment surrounding a power transmission tower of the power system. The method includes the following steps.

(1) With a tower to be assessed in the power transmission lines of the power system as the center, in accordance with the set zone radius, division of an area is performed with different meteorological risk assessment at 0 to 4 levels to get five levels of areas, which are an area of level 4, an area of level 3, an area of level 2, an area of level 1 and an area of level 0.

(2) From monitoring records of a lightning location system inside a power system or in a meteorological system, lightning current amplitudes of lightning flashover to ground within the area of level 4, the area of level 3, the area of level 2 and the area of level 1, for the tower to be assessed, in one hour before the current moment are acquired respectively, the lightning current amplitudes and the direct lightning withstand level llmax for the tower to be assessed are compared, the lightning current amplitude exceeding the direct lightning withstand level llmax for the tower to be assessed is recorded as one valid lightning stroke, and the numbers of the valid lightning strokes in four levels of areas obtained after comparison are recorded as KLR4, KLR3, KLR2 and KLR1, respectively; and

according to the numbers of the valid lightning strokes in four levels of areas, an evaluation equation for a lightning storm risk KL of the tower at the current moment is obtained as follows:

KL=2×(KLR4+KLR3/4+KLR2/9+KLR1/16).

(3) From the meteorological system, the maximum wind speed of the typhoon or windstorm within each of the area of level 4, the area of level 3, the area of level 2 and the area of level 1 for the tower to be assessed at the current moment is acquired, the maximum wind speed and the wind speed Vmax corresponding to the maximum allowable windage yaw for conductors of the tower to be assessed are compared. If the maximum wind speed in the area is greater than the wind speed Vmax corresponding to the maximum allowable windage yaw for conductors of the tower to be assessed, there is a typhoon or windstorm risk in the area and typhoon or windstorm risk in the area of KWR4, KWR3, KWR2 or KWR1 is recorded as 1. If the maximum wind speed in the area is smaller than or equal to the wind speed Vmax corresponding to the maximum allowable windage yaw for conductors of the tower to be assessed, there is no typhoon or windstorm risk for conductors of the tower to be assessed and typhoon or windstorm risk KWR4, KWR3, KWR2 or KWR1 within the area of level 4, the area of level 3, the area of level 2 and the area of level 1 is recorded as 0; and

according to comparison results of typhoon or windstorm risks in four levels of areas, an evaluation equation for the typhoon risk KW of the tower to be assessed at the current moment is obtained as follows:

KW=KWR1+KWR2+KWR3+KWR4.

(4) From the meteorological system, the wildfire monitoring situation within each of the area of level 4, the area of level 3, the area of level 2 and the area of level 1 for the tower to be assessed at the current moment is acquired, and the wildfire disaster risks in four areas of the tower to be assessed are judged according to the wildfire situation. If a wildfire occurs in the area, the wildfire disaster risk in this area of KFR4, KFR3, KFR2 or KFR1 is recorded as 1. If no wildfire occurs in the area, the wildfire disaster risk in this area of KFR4, KFR3, KFR2 or KFR1 is recorded as 0; and

according to judgment results of wildfire disaster risks, an evaluation equation for the wildfire disaster risk KF of the tower to be assessed at the current moment is obtained as follows:

KF=KFR1+KFR2+KFR3+KFR4.

(5) From the meteorological system, the precipitation monitoring data within each of the area of level 4, the area of level 3, the area of level 2 and the area of level 1 for the tower to be assessed at the current moment is acquired, and the maximum precipitation within each level of area is graded according to the common standard of the Meteorological Department. According to the grading result, the rainstorm risks in the four areas of the tower to be assessed are judged respectively. If an extremely heavy rainstorm occurs in the area, the rainstorm risk KRR1, KRR2, KRR3 or KRR4 in this area is recorded as 4. If a heavy rainstorm occurs in the area, the rainstorm risk KRR1, KRR2, KRR3 or KRR4 in this area is recorded as 3. If a rainstorm occurs in the area, the rainstorm risk KRR1, KRR2, KRR3 or KRR4 in this area is recorded as 2. If a heavy rain occurs in the area, the rainstorm risk KRR1, KRR2, KRR3 or KRR4 in this area is recorded as 1. If a moderate or under-moderate rain occurs in the area, the rainstorm risk KRR1, KRR2, KRR3 or KRR4 is recorded as 0; and

according to the judgment result of rainstorm risks, an evaluation equation for the rainstorm risk KR of the tower to be assessed at the current moment is obtained as follows:

KR=(KRR1+KRR2+KRR3+KRR4)/4.

(6) From an online monitoring system for ice coating on the tower of power transmission lines, the monitoring result of an average thick of ice coating on the tower to be assessed at the current moment is acquired, and according to standard grades for ice coating on the tower, the monitoring result is judged. If the average thick of ice coating on the tower reach an extreme grade defined in standard grades for ice coating, the risk KI of ice coating on the tower to be assessed is recorded as 4. If the average thick of ice coating on the tower reach a severe grade defined in standard grades for ice coating, the risk KI of ice coating on the tower to be assessed is recorded as 3. If the average thick of ice coating on the tower reach a relatively severe grade defined in standard grades for ice coating, the risk KI of ice coating on the tower to be assessed is recorded as 2. If the average thick of ice coating on the tower reach a moderate grade defined in standard grades for ice coating, the risk KI of ice coating on the tower to be assessed is recorded as 1. If the average thick of ice coating on the tower reach a low grade defined in standard grades for ice coating, the risk KI of ice coating on the tower to be assessed is recorded as 0.

(7) According to the risk assessment equations in above steps (2) to (6), a combined environmental meteorological risk equation of the tower to be assessed at the current moment is obtained, i.e., KEW=(KL+KW+KF+KR+KI), and thereby a combined environmental meteorological risk result of the tower to be assessed at the current moment is obtained. However, the partition result cannot be used to guide wildfire prevention, and so far, there is no study of division of a risk area for power transmission lines with a wildfire as a risk factor. Thus, in a realistic condition where there is no mature and accurate wildfire forecast model for power transmission lines at present, it is very necessary to study the method of dividing the wildfire risk distribution area for power transmission lines. Division of the wildfire risk area for power transmission lines based on clustering analysis can realize a “different and targeted” strategy to provide a technical basis for wildfire prevention for power transmission lines, to provide a guide for the equipment configuration for wildfire prevention for power transmission lines and the preparedness plan for wildfire prevention, and to achieve the purpose of effectively controlling wildfire risks and ensuring the safe and stable operation of the large power grid.

### SUMMARY

There is no study for dividing a wildfire risk distribution area for power transmission lines at present, thus the present disclosure aims at providing a method for dividing a wildfire risk area for power transmission lines based on clustering analysis, which can find a correlative relationship between wildfires for power transmission lines of different regions within a study area and divide a wildfire risk area for power transmission lines with an innovative idea, a simple operation and strong practicability.

Therefore, the disclosure adopts the following technical solutions. A method for dividing a wildfire risk area for power transmission lines based on clustering analysis includes:

step 1.1 of dividing the wildfire risk area into initial division regions with an administrative region as a unit;

step 1.2 of counting a daily fire-point number of each of the initial division regions according to the wildfire risk area divided in step 1.1;

step 1.3 of counting a daily precipitation of each of the initial division regions according to the wildfire risk area divided in step 1.1;

step 1.4 of establishing at least one index system for characterizing division of the wildfire risk distribution area for the power transmission lines, a number of the at least one index system being n;

step 1.5 of organizing data of the at least one index system established in step 1.4 into m variables to get an m×n matrix M₁,

$${M}_{1} = [ \begin{matrix}{X}_{11} & {X}_{12} & … & … & {X}_{1 n} \\ {X}_{21} & {X}_{22} & … & … & {X}_{2 n} \\ … & … & … & … & … \\ … & … & … & … & … \\ {X}_{m 1} & {X}_{m 2} & … & … & {X}_{m m }\end{matrix} ] ,$$

where n indicates the number of the at least one index system in step 1.4;

step 1.6 of performing a standardization processing on the m variables of M₁ using the following formula so that a mean of each of the variables is 0 and a mean square deviation of each of the variables is 1, and then obtaining a data matrix M₂ after the standardization processing, which eliminates impacts of dimensions and orders of magnitude,

$${X}_{ij}^{′} = \{ \begin{matrix}( {X}_{ij} - {\overline{X}}_{j} ) / {S}_{j} , & {S}_{j} \neq 0 \\ 0 , & {S}_{j} = 0\end{matrix} , \\ {M}_{2} = [ \begin{matrix}{X}_{11}^{″} & {X}_{12}^{″} & … & … & {X}_{1 n}^{″} \\ {X}_{21}^{″} & {X}_{22}^{″} & … & … & {X}_{2 n}^{″} \\ … & … & … & … & … \\ … & … & … & … & … \\ {X}_{m 1}^{″} & {X}_{m 2}^{″} & … & … & {X}_{m m}^{″}\end{matrix} ] ,$$

where a mean of index Xⱼ is

$${\overline{X}}_{j} = \frac{1}{m} {\sum }_{i = 1}^{m} {X}_{ij} ,$$

and a standard deviation of index Xⱼ is

$${S}_{j} = \sqrt{\frac{1}{m - 1} {\sum }_{i = 1}^{m} {( {X}_{ij} - {\overline{X}}_{j} )}^{2 }} , j = 1 , 2 , … , n ;$$

step 1.7 of calculating sample clustering distances in different original categories with an Euclidean distance as a similarity index and according to the above formula, and then obtaining an m×m symmetric matrix D₁ for reflecting a difference between a wildfire risk distribution intensity for the power transmission lines of every two of the categories,

$${d}_{i , j} = \sqrt{{\sum }_{i} {( {x}_{i} - {y}_{i} )}^{2}} , {D}_{1} = [ \begin{matrix}{d}_{11} & {d}_{12} & … & … & {d}_{1 n} \\ {d}_{21} & {d}_{22} & … & … & {d}_{2 n} \\ … & … & … & … & … \\ … & … & … & … & … \\ {d}_{m 1} & {d}_{m 2} & … & … & {d}_{m n }\end{matrix} ] ,$$

where d_{i,j} represents a distance between variables xᵢ=(x₁, x₂, . . . , xₖ) and yᵢ=(y₁, y₂, . . . , yₖ), in which k is a number of indexes for characterizing the wildfire risk distribution area for the power transmission lines, and d_{i,j} reflects a difference of the wildfire risk distribution intensity for the power transmission lines of two regions;

step 1.8 of obtaining a minimum d_{p,q} in the symmetric matrix D₁ obtained in step 1.7, getting similar categories p and q from the minimum d_{p,q}, and merging the similar categories into a new category z, namely z={zₚ, z_{q}};

step 1.9 of obtaining distances between the new category z and the rest of the categories according to the following formula, and then obtaining, for a category containing more than one variable, a (m−1)×(m−1) symmetric matrix for reflecting a difference of a wildfire risk distribution intensity for the power transmission lines of each of the original categories and the new category,

d_{z,j}=min{d_{p,j},d_{q,j}},where j=1,2, . . . ,n, and j≠p,q;

step 1.10 of finding a minimum d_{p′,q′} in the (m−1)×(m−1) symmetric matrix, getting similar categories p′ and q′, and merging the similar categories into a new category z′;

step 1.11 of repeating the steps 1.7 and 1.8 until all the initial categories are merged into one category and a clustering process is recorded, and then selecting a number of categories on demand according to a clustering result graph; and

step 1.12 of dividing the wildfire risk distribution area for the power transmission lines according to the selected number of categories.

As a supplement and perfection to the above technical solution, the disclosure further includes the following technical features.

Indexes in the n index systems include a history daily precipitation, a history daily fire point number, a ratio of a fire point number during the Spring Festival to an annual fire point number, a ratio of a fire point number during the Qingming Festival to an annual fire point number, a vegetation type, and a history wildfire-induced tripping number.

With the present disclosure, the following beneficial effects can be achieved. The present invention moves a sample sequence to another cluster based on satellite monitored fire point data according to the proposed clustering distance index, calculates the clustering distance index many times and then moves it to obtain a clustering result, and thereby obtains a division result of the wildfire risk distribution area for power transmission lines within a study area, for providing a basis for refined forecast of wildfires for power transmission lines and prevention of wildfires for power transmission lines. The present invention can guide, using the method, deployment of fire firefighting teams and materials for high wildfire risk regions for power transmission lines, and enhance the ability to handle wildfires for the power grid.

### BRIEF DESCRIPTION OF THE DRAWINGS

FIG. 1 is a flow diagram of division of the invention.

FIG. 2 is a clustering result graph for division of a nation-wide area.

FIG. 3 is a division result graph of a nation-wide wildfire risk area for power transmission lines.

FIG. 4 is a division result graph of a wildfire risk area for power transmission lines in Hunan province.

### DETAILED DESCRIPTION

Particular embodiments of the disclosure are described below in detail in connection with the drawings.

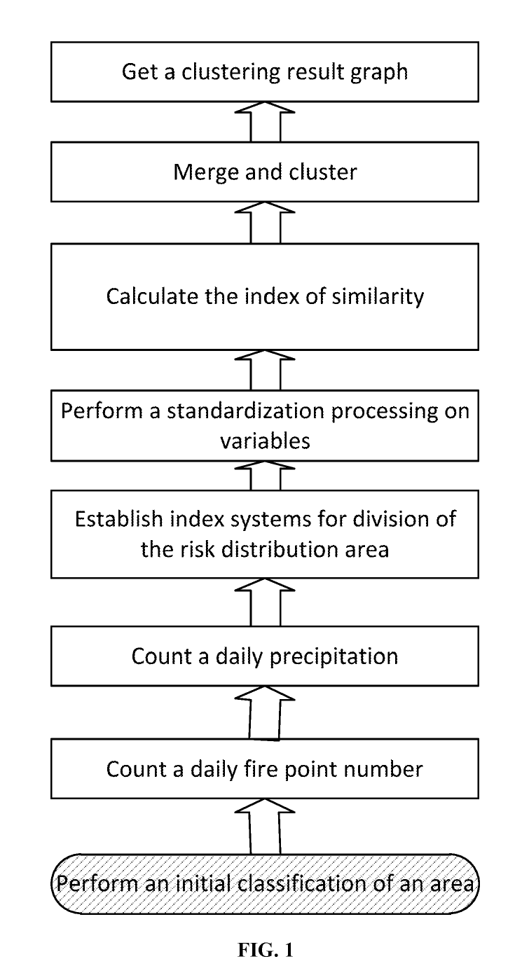

As shown in FIG. 1, a method for dividing a wildfire risk area for power transmission lines based on clustering analysis according to the disclosure includes the following:

step 1.1 of dividing the wildfire risk area into initial division regions with an administrative region as a unit;

step 1.2 of counting a daily fire-point number of each of the initial division regions according to the wildfire risk area divided in step 1.1;

step 1.3 of counting a daily precipitation of each of the initial division regions according to the wildfire risk area divided in step 1.1;

step 1.4 of establishing at least one index system for characterizing division of the wildfire risk distribution area for the power transmission lines, a number of the at least one index system being n;

step 1.5 of organizing data of the at least one index system established in step 1.4 into m variables to get an m×n matrix M₁,

$${M}_{1} = [ \begin{matrix}{X}_{11} & {X}_{12} & … & … & {X}_{1 n} \\ {X}_{21} & {X}_{22} & … & … & {X}_{2 n} \\ … & … & … & … & … \\ … & … & … & … & … \\ {X}_{m 1} & {X}_{m 2} & … & … & {X}_{mn}\end{matrix} ] ,$$

where n indicates the number of the at least one index system in step 1.4;

step 1.6 of performing a standardization processing on the m variables of M₁ using the following formula so that a mean of each of the variables is 0 and a mean square deviation of each of the variables is 1, and then obtaining a data matrix M₂ after the standardization processing, which eliminates impacts of dimensions and orders of magnitude,

$${X}_{ij}^{′} = \{ \begin{matrix}( {X}_{ij} - {\overline{X}}_{j} ) / {S}_{j} , & {S}_{j} \neq 0 \\ 0 , & {S}_{j} = 0\end{matrix} , \\ {M}_{2} = [ \begin{matrix}{X}_{11}^{′} & {X}_{12}^{′} & … & … & {X}_{1 n}^{′} \\ {X}_{21}^{′} & {X}_{22}^{′} & … & … & {X}_{2 n}^{′} \\ … & … & … & … & … \\ … & … & … & … & … \\ {X}_{m 1}^{′} & {X}_{m 2}^{′} & … & … & {X}_{mn}^{′}\end{matrix} ] ,$$

where a mean of index Xⱼ is

$${\overline{X}}_{j} = \frac{1}{m} {\sum }_{i = 1}^{m} {X}_{ij} ,$$

and a standard deviation of index Xⱼ is

$${S}_{j} = \sqrt{\frac{1}{m - 1} {\sum }_{i = 1}^{m} {( {X}_{ij} - {\overline{X}}_{j} )}^{2}} , j = 1 , 2 , … , n ;$$

step 1.7 of calculating sample clustering distances in different original categories with an Euclidean distance as a similarity index and according to the above formula, and then obtaining an m×m symmetric matrix D₁ for reflecting a difference between a wildfire risk distribution intensity for the power transmission lines of every two of the categories,

$${d}_{i , j} = \sqrt{{\sum }_{i} {( {x}_{i} - {y}_{i} )}^{2 }} , {D}_{1} = [ \begin{matrix}{d}_{11} & {d}_{12} & … & … & {d}_{1 n} \\ {d}_{21} & {d}_{22} & … & … & {d}_{2 n} \\ … & … & … & … & … \\ … & … & … & … & … \\ {d}_{m 1} & {d}_{m 2} & … & … & {d}_{mn }\end{matrix} ] ,$$

where d_{i,j} represents a distance between variables xᵢ=(x₁, x₂, . . . , xₖ) and yᵢ=(y₁, y₂, . . . , yₖ), in which k is a number of indexes for characterizing the wildfire risk distribution area for the power transmission lines, and d_{i,j} reflects a difference of the wildfire risk distribution intensity for the power transmission lines of two regions;

step 1.8 of obtaining a minimum d_{p,q} in the symmetric matrix D₁ obtained in step 1.7, getting similar categories p and q from the minimum d_{p,q}, and merging the similar categories into a new category z, namely z={zₚ, z_{q}};

step 1.9 of obtaining distances between the new category z and the rest of the categories according to the following formula, and then obtaining, for a category containing more than one variable, a (m−1)×(m−1) symmetric matrix for reflecting a difference of a wildfire risk distribution intensity for the power transmission lines of each of the original categories and the new category,

d_{z,q}=min{d_{p,j},d_{q,j}}, where j=1,2, . . . ,n, and j≠p,q;

step 1.10 of finding a minimum d_{p′,q′} in the (m−1)×(m−1) symmetric matrix, getting similar categories p′ and q′, and merging the similar categories into a new category z′;

step 1.11 of repeating the steps 1.7 and 1.8 until all the initial categories are merged into one category and a clustering process is recorded, and then selecting a number of categories on demand according to a clustering result graph; and

step 1.12 of dividing the wildfire risk distribution area for the power transmission lines according to the selected number of categories.

Preferably, indexes in the n index systems mainly include a history daily precipitation, a history daily fire point number, a ratio of a fire point number during the Spring Festival to an annual fire point number, a ratio of a fire point number during the Qingming Festival to an annual fire point number, a vegetation type, a history wildfire-induced tripping number and the like.

### Specific Embodiment 1: A Nationwide Area Division

(1) The coverage all over the country except four areas of Hong Kong, Macao, Taiwan, Hainan is divided into 30 initial categories on basis of the administrative region. That is, each provincial-level administrative region forms one category by itself.

(2) From satellite-monitored fire point data and for the provincial-level administrative region, an accumulated daily fire point number is counted in each administrative region for 12 years from Jan. 1, 2001 to Dec. 31, 2012.

(3) From data of ground meteorological observation stations and for the provincial-level administrative region, an accumulated daily precipitation is counted in each administrative region for 12 years from Jan. 1, 2001 to Dec. 31, 2012.

(4) At least one index system for characterizing division of the wildfire risk distribution area for the power transmission lines is established, which mainly includes total 736 indexes, namely, 366 indexes (I₁˜I₃₆₆) of a history accumulated daily precipitation, indexes (I₃₆₇˜I₇₃₂) of a history accumulated daily fire point number, a ratio I₇₃₃ of a fire point number during the Spring Festival to an annual fire point number, a ratio I₇₃₄ of a fire point number during the Qingming Festival to an annual fire point number, a vegetation flammable level I₇₃₅, and a history wildfire-induced tripping number I₇₃₆ and so on.

(5) According to the at least one index system established in step (4), the data is organized into 30 variables to obtain a 30×736 matrix M₁,

$${M}_{1} = [ \begin{matrix}7.8 & 30.18 & … & 1.12 & 30 & 29 & … & 66 & 5 & 257 \\ 10.12 & 11.95 & … & 4.83 & 5 & 10 & … & 7 & 3 & 87 \\ 1.85 & 0.91 & … & 1.5 & 0 & 0 & … & 0 & 4 & 53 \\ … & … & … & … & … & … & … & … & … & … \\ … & … & … & … & … & … & … & … & … & … \\ 3.41 & 3.19 & … & 0.87 & 46 & 51 & … & 26 & 4 & 104 \\ 12.5 & 12.8 & … & 2.5 & 0 & 0 & … & 0 & 2 & 63\end{matrix} ] .$$

(6) A standardization processing is performed on m variables of the matrix M₁ using the formula \textcircled{1}, so that a mean of each of the variables is 0 and a mean square deviation of each of the variables is 1, and then a data matrix M₂ after the standardization processing, which eliminates impacts of dimensions and orders of magnitude, is obtained,

$${X}_{ij}^{′} = \{ \begin{matrix}( {X}_{ij} - {\overline{X}}_{j} ) / {S}_{j} , & {S}_{j} \neq 0 \\ 0 , & {S}_{j} = 0\end{matrix} ,$$

where a mean of index Xⱼ is

$${\overline{X}}_{j} = \frac{1}{m} {\sum }_{i = 1}^{m} {X}_{ij} ,$$

and a standard deviation of index Xⱼ is

$${S}_{j} = \sqrt{\frac{1}{m - 1} {\sum }_{i = 1}^{m} {( {X}_{ij} - {\overline{X}}_{j} )}^{2}} , j = 1 , 2 , … , n . \\ {M}_{2} = [ \begin{matrix}0.14853 & 1.59387 & … & - 0.64666 & 0.15080 & 0.11209 & … & 0.96590 & 1.22788 & 1.73619 \\ 0.66748 & 0.01249 & … & 1.65134 & - 0.29545 & - 0.27391 & … & - 0.29567 & - 0.52623 & - 0.31064 \\ - 1.18241 & - 0.94518 & … & - 0.41129 & - 0.38470 & - 0.47707 & … & - 0.44535 & 0.35082 & - 0.72000 \\ … & … & … & … & … & … & … & … & … & … \\ … & … & … & … & … & … & … & … & … & … \\ - 0.83346 & - 0.74740 & … & - 0.80151 & 0.43640 & 0.55903 & … & 0.11060 & 0.43082 & - 0.10595 \\ 1.19986 & 0.08623 & … & 0.20812 & - 0.38470 & - 0.47707 & … & - 0.44535 & - 1.40329 & - 0.59960\end{matrix} ] .$$

(7) Sample clustering distances in different original categories are calculated with an Euclidean distance as a similarity index and according to formula \textcircled{2}, and then an m×m symmetric matrix D₁ is obtained for reflecting a difference between a wildfire risk distribution intensity for the power transmission lines of every two of the categories,

$${d}_{i , j} = \sqrt{{\sum }_{i} {( {x}_{i} - {y}_{i} )}^{2}} ,$$

where d_{i,j} represents a distance between variables xᵢ=(x₁, x₂, . . . , xₖ) and yᵢ=(y₁, y₂, . . . , yₖ), in which k is a number of indexes for characterizing the wildfire risk distribution area for the power transmission lines, and d_{i,j} reflects a difference of the wildfire risk distribution intensity for the power transmission lines of two regions.

(8) A minimum d_{p,q} is found in the symmetric matrix D₁ obtained in step (7), categories p and q are considered as the most similar categories, and the most similar categories are merged into a new category z, namely z={zₚ, z_{q}}.

(9) Distances between the new category z and the rest of the categories are calculated. For a category containing more than one variable, a distance between each of the original categories and the new category is calculated according to formula \textcircled{3} to obtain a (m−1)×(m−1) symmetric matrix for reflecting a difference of a wildfire risk distribution intensity for the power transmission lines between each of the original categories and the new category,

d_{z,j}=min{d_{p,j},d_{q,j}} \textcircled{3}

where j=1, 2, . . . , n, and j≠p,q.

(10) A minimum d_{p′,q′} is found in the (m−1)×(m−1) symmetric matrix, categories p′ and q′ are considered as the most similar categories, and the most similar categories are merged into a new category z′.

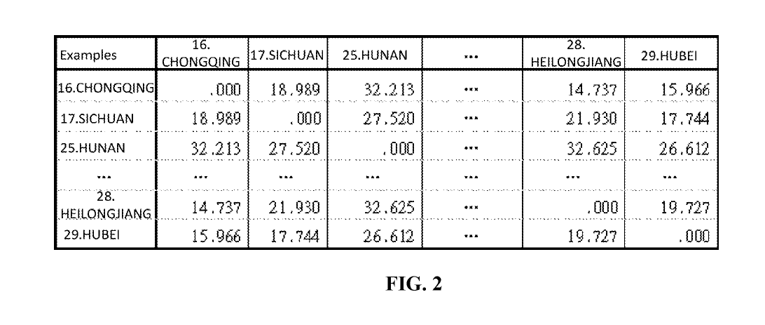

(11) The steps (7) and (8) are repeated until all the initial categories are merged into one category and a clustering process is recorded, and as shown in FIG. 2, the number of categories is selected on demand, according to a clustering result graph.

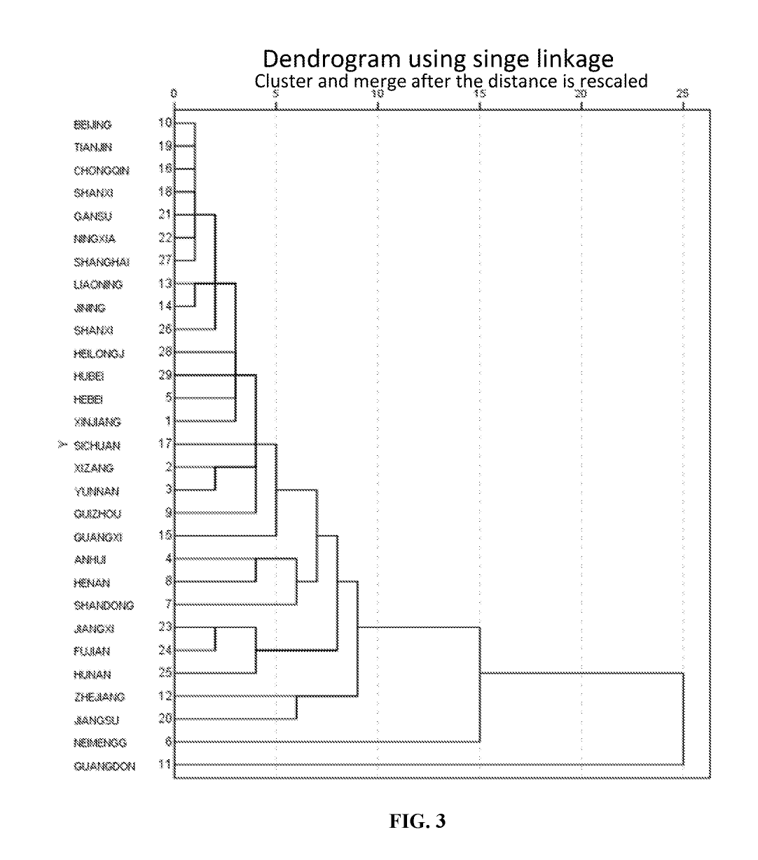

(12) The wildfire risk distribution area for the power transmission lines is divided and is analyzed according to the selected number of categories. The result is shown in FIG. 3.

### Specific Embodiment 2: Division of a Wildfire Risk Area for Power Transmission Lines in Hunan Province

(1) The coverage of Hunan province is divided into 14 initial categories on basis of the administrative region. That is, each prefecture-level administrative region forms one category by itself.

(2) From satellite-monitored fire point data and for the prefecture-level administrative region, an accumulated daily fire point number is counted in each administrative region for 12 years from Jan. 1, 2001 to Dec. 31, 2012.

(3) From data of ground meteorological observation stations and for the prefecture-level administrative region, an accumulated daily precipitation is counted in each administrative region for 12 years from Jan. 1, 2001 to Dec. 31, 2012.

(4) At least one indexes for characterizing division of the risk distribution area for the power transmission lines is established, which mainly includes total 736 indexes, namely, 366 indexes (I₁˜I₃₆₆) of a history accumulated daily precipitation, indexes (I₃₆₇˜I₇₃₂) of a history accumulated daily fire point number, a ratio I₇₃₃ of a fire point number during the Spring Festival to an annual fire point number, a ratio I₇₃₄ of a fire point number during the Qingming Festival to an annual fire point number, a vegetation flammable level I₇₃₅, and a history wildfire-induced tripping number I₇₃₆ and so on.

(5) According to the at least one index system established in step (4), the data is organized into 31 variables to obtain a 31×734 matrix M₁.

Steps (6) to (10) are the same as that of embodiment 1.

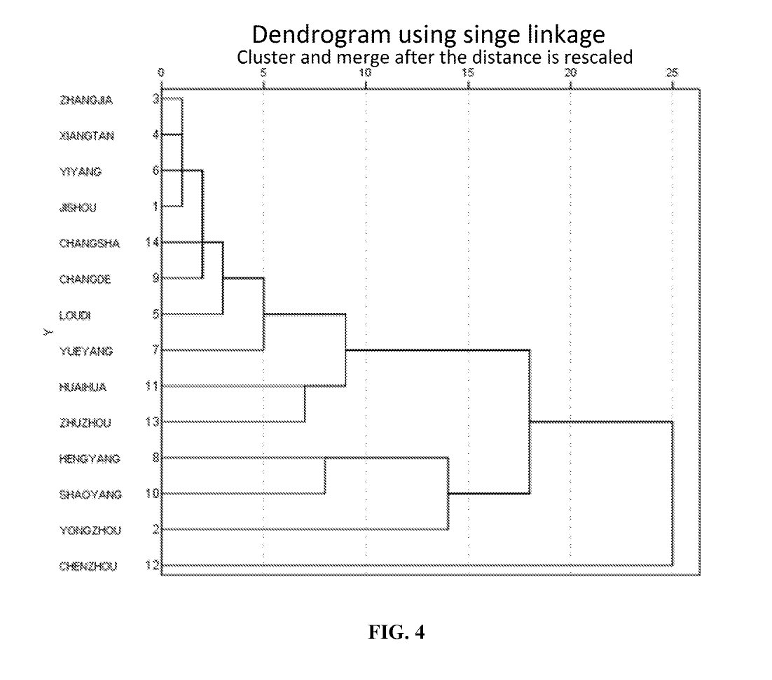

(12) The wildfire risk distribution area for the power transmission lines is divided according to the selected number of categories. The result is shown in FIG. 4.

The present invention establishes at least one index system for reflecting, in a comprehensive manner, wildfire risk characteristics for power transmission lines, based on meteorological factor, satellite-monitored data of a wildfire fire point, a vegetation type and so on. A wildfire area for power transmission lines all over the country or province is divided scientifically using clustering analysis, the power system is divided objectively into several regions for which risk characteristics with a wildfire as a risk factor are very different with respect to each other, and the disclosure provides a decision reference for design of power transmission lines, wildfire prevention and the like.

The present invention moves a sample sequence to another cluster based on satellite monitored fire point data and according to the proposed clustering distance index, calculates the clustering distance index many times and then moves it to obtain a clustering result, and thereby obtains a division result of the wildfire risk distribution area for power transmission lines within a study area, for providing a basis for refined forecast of wildfires for power transmission lines and prevention of wildfires for power transmission lines. The present invention can guide, using the method, deployment of fire firefighting teams and materials for high wildfire risk regions for power transmission lines, and enhance the ability to handle wildfires for the power grid.

The basic principles and main features of the disclosure and the advantages of the disclosure are showed and described above. Those skilled in the art should understand that the disclosure is not limited to the above embodiments, and the above embodiments and description in the specification are only principles for explaining the disclosure. There are many variations and modifications of the disclosure without depart from the spirit and scope of the disclosure, and such variations and modifications fall within the scope of protection claimed in the disclosure. The scope of protection claimed in the disclosure is defined by the appending claims and their equivalents.

What is claimed is:

1. A method for dividing a wildfire risk area for power transmission lines based on clustering analysis, wherein the method for dividing the wildfire risk area comprises:
step 1.1 of dividing the wildfire risk area into initial division regions with an administrative region as a unit;
step 1.2 of counting a daily fire-point number of each of the initial division regions according to the wildfire risk area divided in step 1.1;
step 1.3 of counting a daily precipitation of each of the initial division regions according to the wildfire risk area divided in step 1.1;
step 1.4 of establishing at least one index system for characterizing division of the wildfire risk distribution area for the power transmission lines, a number of the at least one index system being n;
step 1.5 of organizing data of the at least one index system established in step 1.4 into m variables to get an m×n matrix M₁,
$${M}_{1} = [ \begin{matrix}{X}_{11} & {X}_{12} & … & … & {X}_{1 n} \\ {X}_{21} & {X}_{22} & … & … & {X}_{2 n} \\ … & … & … & … & … \\ … & … & … & … & … \\ {X}_{m 1} & {X}_{m 2} & … & … & {X}_{mn}\end{matrix} ] ,$$
where n indicates the number of the at least one index system in step 1.4;
step 1.6 of performing a standardization processing on the m variables of M₁ using the following formula so that a mean of each of the variables is 0 and a mean square deviation of each of the variables is 1, and then obtaining a data matrix M₂ after the standardization processing, which eliminates impacts of dimensions and orders of magnitude,
$${X}_{ij}^{′} = \{ \begin{matrix}( {X}_{ij} - {\overline{X}}_{j} ) / {S}_{j} , & {S}_{j} \neq 0 \\ 0 , & {S}_{j} = 0\end{matrix} , \\ {M}_{2} = [ \begin{matrix}{X}_{11}^{′} & {X}_{12}^{′} & … & … & {X}_{1 n}^{′} \\ {X}_{21}^{′} & {X}_{22}^{′} & … & … & {X}_{2 n}^{′} \\ … & … & … & … & … \\ … & … & … & … & … \\ {X}_{m 1}^{′} & {X}_{m 2}^{′} & … & … & {X}_{mn}^{′}\end{matrix} ] ,$$
where a mean of index Xⱼ is
$${\overline{X}}_{j} = \frac{1}{m} {\sum }_{i = 1}^{m} {X}_{ij} ,$$
and a standard deviation of index Xⱼ is
$${S}_{j} = \sqrt{\frac{1}{m - 1} {\sum }_{i = 1}^{m} {( {X}_{ij} - {\overline{X}}_{j} )}^{2}} , j = 1 , 2 , … , n ;$$
step 1.7 of calculating sample clustering distances in different original categories with an Euclidean distance as a similarity index and according to the above formula, and then obtaining an m×m symmetric matrix D₁ for reflecting a difference between a wildfire risk distribution intensity for the power transmission lines of every two of the categories,
$${d}_{i , j} = \sqrt{{\sum }_{i} {( {x}_{i} - {y}_{j} )}^{2 }} , {D}_{1} = [ \begin{matrix}{d}_{11} & {d}_{12} & … & … & {d}_{1 n} \\ {d}_{21} & {d}_{22} & … & … & {d}_{2 n} \\ … & … & … & … & … \\ … & … & … & … & … \\ {d}_{m 1} & {d}_{m 2} & … & … & {d}_{mn }\end{matrix} ] ,$$
where d_{i,j} represents a distance between variables xᵢ=(x₁, x₂, . . . , xₖ) and yᵢ=(y₁, y₂, . . . , yₖ), in which k is a number of indexes for characterizing the wildfire risk distribution area for the power transmission lines, and d_{i,j} reflects a difference of the wildfire risk distribution intensity for the power transmission lines of two regions;
step 1.8 of obtaining a minimum d_{p,q} in the symmetric matrix D₁ obtained in step 1.7, getting similar categories p and q from the minimum d_{p,q}, and merging the similar categories into a new category z, namely z={zₚ, z_{q}};
step 1.9 of obtaining distances between the new category z and the rest of the categories according to the following formula, and then obtaining, for a category containing more than one variable, a (m−1)×(m−1) symmetric matrix for reflecting a difference of a wildfire risk distribution intensity for the power transmission lines of each of the original categories and the new category,
d_{z,j}=min{d_{p,j},d_{q,j}}, where j=1,2, . . . n, and j≠p,q;
step 1.10 of finding a minimum d_{p′,q′} in the (m−1)×(m−1) symmetric matrix, getting similar categories p′ and q′, and merging the similar categories into a new category z′;
step 1.11 of repeating the steps 1.7 and 1.8 until all the initial categories are merged into one category and a clustering process is recorded, and then selecting a number of categories on demand according to a clustering result graph; and
step 1.12 of dividing the wildfire risk distribution area for the power transmission lines according to the selected number of categories.

2. The method for dividing the wildfire risk area for the power transmission lines based on clustering analysis according to claim 1, wherein indexes in the n index systems include a history daily precipitation, a history daily fire point number, a ratio of a fire point number during the Spring Festival to an annual fire point number, a ratio of a fire point number during the Qingming Festival to an annual fire point number, a vegetation type, and a history wildfire-induced tripping number.
